(19) United States
(12) Patent Application Publication
(10) Pub. No.: US 2009/0203810 A1
(43) Pub. Date: Aug. 13, 2009

(54) FOAMED, LIGHTFAST POLYURETHANE REACTION MIXTURES, PROCESSES FOR PREPARING MOLDINGS THEREWITH, AND MOLDINGS PRODUCED THEREBY

(75) Inventors: Peter Haas, Haan (DE); Hans-Detlef Arntz, Lohmar (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/365,936

(22) Filed: Feb. 5, 2009

(30) Foreign Application Priority Data
Feb. 9, 2008 (DE) 102008008391.7

(51) Int. Cl. C08J 9/04

(52) U.S. Cl. 521/118

(57) ABSTRACT

Foamed, lightfast polyurethane reaction mixtures, and moldings produced therefrom, comprising: (a) an isocyanate component comprising one or more selected from the group consisting of aliphatic isocyanates, aliphatic isocyanate prepolymers and mixtures thereof; (b) a polyol component having an average molecular weight of 1,000-15,000 g/mol and an average functionality of 2 to 8; (c) a chain extension/crosslinking component comprising one or more selected from the group consisting of polyols and polyamines having a molecular weight of 62-500 g/mol and a functionality of 2 to 8; and (e) a blowing agent comprising an ammonium carbamate salt of formula (I) having at least two OH groups:

HO—X—N(R¹)H₂⁺⁻O—C(O)—N(R¹)—X—OH (I)

wherein each R¹ independently represents a moiety selected from the group consisting of H, C₁-C₅ alkyl radicals, and —X—OH groups; wherein each X independently represents a moiety selected from the group consisting of —[CR²R³]ₙ— wherein n represents a number of 2 to 6, —(CR²R³)ₚO—(—CR²R³ₚ]_{q}— wherein p represents a number of 2 to 4 and q represents a number of 1 to 10, and —(CR²R³)N(R⁴)CR²R³ᵣ]ₛ— wherein r represents a number of 2 to 4 and s represents a number of 1 to 10; wherein each R² and each R³ independently represents a moiety selected from the group consisting of H and C₁-C₅ alkyl radicals; and wherein each R⁴ independently represents a moiety selected from the group consisting of H, C₁-C₅ alkyl radicals, and —X—OH groups.

### BACKGROUND OF THE INVENTION

Polyurethanes (PURs) based on isocyanates with aromatic-bound NCO groups are known to have a tendency to discolor under the action of light. This is a problem in exterior applications or for interior parts subject to the action of light. To produce light-resistant moldings, therefore, a surface with appropriate properties is needed.

To produce polyurethanes (PURs) with high light resistance, aliphatically bound isocyanates are usually employed. A use of such isocyanates for the production of light-resistant PURs is described in European Patent Pub. No. EP0379246B1, the entire contents of which are incorporated herein by reference. Here, light-resistant covering skins, e.g. for use on instrument panels, are produced. It is possible to manufacture solid and foamed aliphatic skins. The use of water as blowing agent leads to relatively high hardness in the foams, which is undesirable in some cases, displaying even greater hardness values than the solid skins in the low density range. In addition, it is generally problematic to coordinate the catalysis of blowing and crosslinking reactions when aliphatic isocyanates are used. In this case, it is often necessary to work with specific metal catalysts.

Moreover, surfaces in the interior area also have to take on a certain protective function by exhibiting a surface finish which is soft under stress but which regains its original contours again after a relatively short period.

In European Patent Pub. No. EP0652250A1, the entire contents of which are incorporated herein by reference, a process for the production of cellular polyurethanes made from isocyanates of the diphenylmethane series and carbamate blowing agents is described. However, these foams display shrinkage values that are too high. Such changes in the dimensional stability of moldings are undesirable. Thermal expansion should also be as low as possible.

### BRIEF SUMMARY OF THE INVENTION

The invention relates, in general, to foamed, lightfast polyurethane moldings and the use thereof.

One object of the present invention was to provide lightfast polyurethanes in a broad range of densities with soft elastic surface behaviour (haptics), e.g. for the areas of application of dashboards, door trim panels, arm rests and consoles, which additionally display low shrinkage behaviour, as well as a process for the production thereof.

Surprisingly, it has been found that such lightfast polyurethanes having low shrinkage behaviour in a broad range of densities with soft elastic surface behaviour can be provided via polyurethanes which are obtainable from aliphatic isocyanates and short- and long-chain compounds which are reactive towards isocyanates with the use of specific ammonium carbamates as a blowing agent.

The present invention provides foamed, lightfast polyurethane moldings obtainable from
A) aliphatic isocyanates and/or aliphatic isocyanate prepolymers, which may optionally be modified,
B) polyols with an average molecular weight of 1,000-15,000 g/mol and a functionality of 2 to 8, preferably of 2 to 4,
C) polyols or polyamines with a molecular weight of 62-500 g/mol and a functionality of 2 to 8, preferably 2 to 4, as chain extenders/crosslinking agents,
D) optionally other auxiliary substances and additives,
E) blowing agents,
   characterised in that as blowing agents, at least 2 OH group-containing ammonium carbamate salts of formula I) are used

HO—X—N(R¹)H₂⁺⁻O—C(O)—N(R¹)—X—OH (I)

R¹=H, C₁-C₅ alkyl radical or —X—OH

X=[CR²R³]ₙ n=2-6
=(CR²R³)ₚO—(—CR²R³ₚ]_{q} p=2-4 q=1-10
=(CR²R³)N(R⁴)CR²R³ᵣ]ₛ r=2-4 s=1-10

R², R³=H, C₁-C₅ alkyl radical

R⁴=H, C₁-C₅ alkyl radical or —X—OH

One embodiment of the present invention includes foamed, lightfast polyurethane reaction mixtures comprising:
(a) an isocyanate component comprising one or more selected from the group consisting of aliphatic isocyanates, aliphatic isocyanate prepolymers and mixtures thereof;
(b) a polyol component having an average molecular weight of 1,000-15,000 g/mol and an average functionality of 2 to 8;
(c) a chain extension/crosslinking component comprising one or more selected from the group consisting of polyols and polyamines having a molecular weight of 62-500 g/mol and a functionality of 2 to 8; and
(e) a blowing agent comprising an ammonium carbamate salt of formula (I) having at least two OH groups:

HO—X—N(R¹)H₂⁺⁻O—C(O)—N(R¹)—X—OH (I)

wherein each R¹ independently represents a moiety selected from the group consisting of H, C₁-C₅ alkyl radicals, and —X—OH groups; wherein each X independently represents a moiety selected from the group consisting of —[CR²R³]ₙ— wherein n represents a number of 2 to 6,—(CR²R³)ₚO—(—CR²R³ₚ]_{q}— wherein p represents a number of 2 to 4 and q represents a number of 1 to 10, and —(CR²R³)N(R⁴)CR²R³ᵣ]ₛ— wherein r represents a number of 2 to 4 and s represents a number of 1 to 10; wherein each R² and each R³ independently represents a moiety selected from the group consisting of H and C₁-C₅ alkyl radicals; and wherein each R⁴ independently represents a moiety selected from the group consisting of H, C₁-C₅ alkyl radicals, and —X—OH groups.

Another embodiment of the present invention includes processes for preparing moldings from the reaction mixtures according to the invention, wherein the processes comprise providing a polyurethane reaction mixture according to any of the various embodiments of the invention, and reacting the mixture in a closed mold.

The present invention also includes moldings prepared in accordance with the process embodiments of the invention.

### DETAILED DESCRIPTION OF THE INVENTION

As used herein, the singular terms “a” and “the” are synonymous and used interchangeably with “one or more” and “at least one,” unless the language and/or context clearly indicates otherwise. Accordingly, for example, reference to “an isocyanate component” herein or in the appended claims can refer to a single isocyanate component or more than one isocyanate component. Additionally, all numerical values, unless otherwise specifically noted, are understood to be modified by the word “about.”

The production of suitable ammonium carbamates is described, for example, in U.S. Pat. No. 5,464,880, the entire contents of which are incorporated herein by reference.

As isocyanates A), (cyclo)aliphatic polyisocyanates, preferably diisocyanates, are used. To produce the polyurethanes according to the invention, isophorone diisocyanate (IPDI) and hexamethylene diisocyanate (HDI) are particularly suitable. The isocyanates can be used in the form of the pure compound or in modified form, e.g. in the form of uretdiones, isocyanurates, allophanates or biurets, or in the form of urethane-group- and isocyanate-group-containing reaction products, so-called isocyanate prepolymers, and/or carbodiimide-modified isocyanates. The isocyanates A) preferably have an isocyanate content of 35 to 15 wt. %. Preferred isocyanate components are low-viscosity products based on IPDI with a monomer proportion of 95 to 45 wt. %, preferably 90-55 wt. %.

The component B) has an average hydroxyl functionality of 2 to 8 and preferably consists of at least one polyhydroxy polyether with an average molecular weight of 1,000 to 15,000 g/mol, preferably 2,000 to 13,000 g/mol, and/or at least one polyhydroxy polyester with an average molecular weight of 2,000 to 10,000 g/mol, preferably 2,000 to 8,000 g/mol.

Suitable polyhydroxy polyethers are the alkoxylation products of preferably di- or trifunctional starter molecules known per se from polyurethane chemistry or mixtures of these starter molecules. Suitable starter molecules are e.g. water, ethylene glycol, diethylene glycol, propylene glycol, trimethylolpropane, glycerol and sorbitol. Alkylene oxides used for the alkoxylation are in particular propylene oxide and ethylene oxide, it being possible to use these alkylene oxides in any order and/or as a mixture.

Suitable polyester polyols are the hydroxyl group-containing esterification products, which are known per se, of preferably dihydric alcohols, such as e.g. ethylene glycol, propylene glycol, neopentyl glycol, 1,4-butanediol, 1,6-hexanediol, with substoichiometric quantities of preferably difunctional carboxylic acids, such as e.g. succinic acid, adipic acid, phthalic acid, tetrahydrophthalic acid, hexahydrophthalic acid or mixtures of such acids.

The component C) is preferably constituted by difunctional chain extenders with a molecular weight of 62 to 500 g/mol, preferably 62 to 400 g/mol. The preferred chain extenders C) include dihydric alcohols, such as e.g. ethylene glycol, diethylene glycol, 1,4-butanediol, 1,6-hexanediol or mixtures of such diols. Also suitable as component C) or as part of component C) are ether group-containing diols with molecular weights of less than 400 g/mol, as can be obtained by propoxylation and/or ethoxylation of divalent starter molecules of the type already mentioned above by way of example. Also suitable as chain extenders C) are diamines with amino groups in the aryl-alkyl position, such as e.g. 1,3-xylyenediamine. Any mixtures of the chain extenders mentioned by way of example can also be used. The chain extenders C) are used in quantities of 2 to 15, preferably 4 to 12 wt. %, based on the weight of component B).

The carbamates (e) are compounds of the general formulae already mentioned above.

The carbamates can be produced by simple saturation of the alkanolamines on which they are based with gaseous or solid carbon dioxide at temperatures of between 40 and 130° C.

Particularly preferred alkanolamines for the production of the carbamates are ethanolamine, isopropanolamine, 3-amino-1-propanol, N-methylethanolamine, 2-(2-aminoethoxy)ethanol, N-(2-aminoethyl)ethanolamine or mixtures of such alkanolamines.

In the production of the polyurethanes (PURs), the carbamate used as blowing agent is used in a quantity of 0.1 to 6, preferably 0.5 to 5 wt. %, based on the weight of component B).

As auxiliary substances and additives D), compounds of the type known per se are used.

Auxiliary substances and additives D) that can optionally be incorporated are the compounds conventional in the production of polyurethane foams, such as e.g. activators, stabilisers or other halogen-free blowing agents, such as in particular water, which is optionally incorporated in a quantity of up to 0.3 wt. %, based on the weight of component B). However, the production of the PURs preferably takes place without any added water.

The starting components are, moreover, used in quantities such that an isocyanate number of 80 to 120, preferably 95 to 105, is obtained.

For the production of the PURs, the components B) to B) are generally combined to form a “polyol component” which is then mixed with the polyisocyanate component A) and reacted in closed molds. During this operation, conventional measuring and metering devices are employed.

The moldings are used for example as steering wheels or door trim panels as well as instrument panel covers or generally as protective padding in car interiors.

The aliphatic foams are suitable as cladding for dashboards, consoles, claddings for doors or glove compartments in the vehicles sector.

The temperature of the reaction components (polyisocyanate component A) or polyol component) is generally within the temperature range of 20 to 60° C. The temperature of the molds is generally 20 to 90° C.

The quantity of the foamable material introduced into the mold is such that densities of the moldings of 200 to 700 kg/m³ result.

The invention will now be described in further detail with reference to the following non-limiting examples.

### EXAMPLES

### Polyisocyanate I:

Aliphatic polyisocyanate (with an IPDI content of 70 wt. % and an IPDI isocyanurate content of 30 wt. %) with an NCO content of 30.5 wt. % and a viscosity of 200 mPas at 25° C.

### Polyol I:

Polyether polyol with an OH number of 27; produced by alkoxylation of trimethylolpropane with propylene oxide/ethylene oxide (PO/EO) in a weight ratio of 78:22 and predominantly primary OH end groups.

### Polyol II:

Polyether polyol with an OH number of 37; produced by alkoxylation of glycerol with propylene oxide/ethylene oxide (PO/EO) in a weight ratio of 28:72 and predominantly primary OH end groups.

### Polyol III:

Polyether polyol with an OH number of 640; produced by addition of propylene oxide to ethylenediamine with secondary OH end groups.

### Carbamate I:

5 moles of CO₂ are introduced into a solution of 610 g aminoethanol and 830 g ethylene glycol until saturation is reached.

A 50 wt. % solution of the carbamate is formed.

| | |
|---|---|
| Acid value: 166 mg KOH/g | calculated: 168.9 mg KOH/g |
| Amine value: 335 mg KOH/g | calculated: 337.9 mg KOH/g |

### Carbamate II:

1 mole of CO₂ is introduced into a solution of 210 g 2-(2-aminoethoxy)ethanol and 254 g ethylene glycol until saturation is reached.

A 50 wt. % solution of the carbamate is formed.

| | |
|---|---|
| Acid value: 107 mg KOH/g | calculated: 110 mg KOH/g |
| Amine value: 219 mg KOH/g | calculated: 220 mg KOH/g |

In table 1 below, the components for the production of the PURs are described. The percentage data in table 1 relate to the weight.

TABLE 1
Compositions

| | Example | | | |
|---|---|---|---|---|
| | 1 | 2 | 3 | 4 |
| Polyol I | 84.5 | 89.5 | 74.5 | 89.5 |
| Polyol II | 5.0 | — | 15.0 | — |
| Polyol III | 1.5 | 1.5 | 1.5 | 1.5 |
| Isophoronediamine (chain extender) | 1.5 | 1.5 | 1.5 | 1.5 |
| Pigment paste Isopur ® Como beige; | 6.0 | 6.0 | 6.0 | 6.0 |
| from ISL-Chemie | | | | |
| UOP-L powder (zeolite powder); from UOP | 1.0 | 1.0 | 1.0 | 1.0 |
| Dabco XF U2018 (catalyst); from Air | 1.0 | 2.0 | 1.0 | 1.0 |
| Products | | | | |
| 1,4-Butanediol | 4.0 | — | 4.0 | — |
| Diethylene glycol | — | 4.0 | — | 4.0 |
| Tegostab B 8936 (stabiliser); | 1.0 | 1.0 | 1.0 | 1.0 |
| from Goldschmidt-Degussa | | | | |
| Amine catalyst Polycat 15; from Air | — | — | 0.3 | — |
| Products | | | | |
| Carbamate I | 3.0 | 3.0 | 3.0 | |
| Carbamate II | — | — | — | 5.0 |
| Isocyanate I | 35.3 | 32.9 | 35.6 | 37.4 |
| Dabco XF U2031 (metal activator); | 0.4 | 0.4 | 0.4 | 0.4 |
| from Air Products | | | | |

TABLE 2
Properties

| | Example | | | |
|---|---|---|---|---|
| | 1 | 2 | 3 | 4 |
| Density [kg/m³] measured acc. | 600 | 500 | 500 | 500 |
| to DIN 53 568 | | | | |
| Shore A hardness measured acc. | 39 | 35 | 37 | 45 |
| to DIN 53 505 | | | | |
| Tensile strength [MPa] | 1.7 | 1.8 | 1.4 | 1.5 |
| measured acc. to DIN 53 504 | | | | |
| Elongation at break [%] | 192 | 180 | 175 | 195 |
| measured acc. to DIN 53 504 | | | | |
| Tear propagation resistance [kN/m] | 6 | 6 | 6 | 6 |
| measured acc. to DIN 53 515 | | | | |
| Rebound resilience [%] | 27 | 29 | 25 | 32 |
| measured acc. to DIN 53 512 | | | | |
| Demold time [sec.] | 150 | 150 | 90 | 150 |
| Shrinkage [%] after | 0.20 | 0.15 | 0.20 | 0.15 |
| 2 days in longitudinal direction | | | | |

The reaction ratios for the components relate to 100 parts by weight of the polyol formulation for the quantity of isocyanate given in table 1.

The mold temperature was 80° C. and the mold size was 200×200×5 mm.

The temperature of the components used was room temperature (25° C.) for the isocyanate and 50° C. for the polyol formulation.

The working pressures during the conventional machine processing by the RIM process were 200 bar in each case on the isocyanate side and the polyol side.

The quantity introduced into the mold was calculated so as to result in the density specified.

The aliphatic polyurethane foams exhibit a defect-free surface; after being loaded, they display recovery behaviour which results in the original surface structure again with a slight time delay. The impact points of the balls during measurement of the falling ball rebound resilience disappeared completely.

In addition to the delayed resilience of the surface after loading, the substantially lower hardness of the PUR foams compared with the polyurethanes from examples 18-21 of EP-A 0 379 246 is also advantageous. Compared with the PURs from the examples from EP-A 0 652 250, the polyurethane foams of the present invention surprisingly exhibit substantially lower shrinkage. As a result, there is an advantageous high dimensional stability, e.g. in foamed skins.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A foamed, lightfast polyurethane reaction mixture comprising:
(a) an isocyanate component comprising one or more selected from the group consisting of aliphatic isocyanates, aliphatic isocyanate prepolymers and mixtures thereof;
(b) a polyol component having an average molecular weight of 1,000-15,000 g/mol and an average functionality of 2 to 8;
(c) a chain extension/crosslinking component comprising one or more selected from the group consisting of polyols and polyamines having a molecular weight of 62-500 g/mol and a functionality of 2 to 8; and
(e) a blowing agent comprising an ammonium carbamate salt of formula (I) having at least two OH groups.
HO—X—N(R¹)H₂⁺⁻O—C(O)—N(R¹)—X—OH (I)
wherein each R¹ independently represents a moiety selected from the group consisting of H, C₁-C₅ alkyl radicals, and —X—OH groups; wherein each X independently represents a moiety selected from the group consisting of —[CR²R³]ₙ— wherein n represents a number of 2 to 6, —(CR²R³)ₚO—(—CR²R³ₚ]_{q}— wherein p represents a number of 2 to 4 and q represents a number of 1 to 10, and —(CR²R³)N(R⁴)CR²R³ᵣ]ₛ— wherein r represents a number of 2 to 4 and s represents a number of 1 to 10; wherein each R² and each R³ independently represents a moiety selected from the group consisting of H and C₁-C₅ alkyl radicals; and wherein each R⁴ independently represents a moiety selected from the group consisting of H, C₁-C₅ alkyl radicals, and —X—OH groups.

2. The foamed, lightfast polyurethane reaction mixture according to claim 1, wherein the isocyanate component has an isocyanate content of 15 to 35 wt. %.

3. The foamed, lightfast polyurethane reaction mixture according to claim 1, wherein the isocyanate component comprises an isocyanate containing isophorone diisocyanate having a monomer proportion of 45 to 95 wt. %.

4. The foamed, lightfast polyurethane reaction mixture according to claim 1 wherein the polyol component has an average functionality of 2 to 4.

5. The foamed, lightfast polyurethane reaction mixture according to claim 1, wherein the polyol component has an average molecular weight of 2,000-13,000 g/mol.

6. The foamed, lightfast polyurethane reaction mixture according to claim 1, wherein the polyol component comprises at least one polyhydroxy polyether and has an average molecular weight of 2,000-8,000 g/mol.

7. The foamed, lightfast polyurethane reaction mixture according to claim 1, wherein the chain extension/crosslinking component is present in an amount of 2 to 15 wt. %,

8. The foamed, lightfast polyurethane reaction mixture according to claim 1, wherein the ammonium carbamate salt of formula (I) is prepared by a process comprising saturating one or more alkanolamines with carbon dioxide at a temperature of 40 to 130° C.

9. The foamed, lightfast polyurethane reaction mixture according to claim 8, wherein the one or more alkanolamines comprises a compound selected from the group consisting of ethanolamine, isopropanolamine, 3-amino-1-propanol, N-methylethanolamine,2-(2-aminoethoxy)ethanol, N-(2-aminoethyl)ethanolamine, and mixtures thereof.

10. A foamed, lightfast polyurethane reaction mixture comprising:
(a) an isocyanate component comprising isophorone diisocyanate having a monomer proportion of 45 to 95 wt. %;
(b) a polyol component comprising at least one polyhydroxy polyether and having an average molecular weight of 2,000-8,000 g/mol and an average functionality of 2 to 4;
(c) a chain extension/crosslinking component comprising one or more selected from the group consisting of polyols and polyamines having a molecular weight of 62-400 g/mol and a functionality of 2 to 4; and
(e) a blowing agent comprising an ammonium carbamate salt of formula (I) having at least two OH groups, prepared by a process comprising saturating one or more alkanolamines selected from the group consisting of ethanolamine, isopropanolamine, 3-amino-1-propanol, N-methylethanolamine, 2-(2-aminoethoxy)ethanol, N-(2-aminoethyl)ethanolamine, and mixtures thereof, with carbon dioxide at a temperature of 40 to 130° C.;
HO—X—N(R¹)H₂⁺⁻O—C(O)—N(R¹)—X—OH (I).

11. The foamed, lightfast polyurethane reaction mixture according to claim 1, further comprising (d) one or more auxiliary substances or additives.

12. The foamed, lightfast polyurethane reaction mixture according to claim 10, further comprising (d) one or more auxiliary substances or additives.

13. A foamed, lightfast polyurethane molding prepared by a process comprising providing the polyurethane reaction mixture according to claim 1, and reacting the mixture in a closed mold.

14. A foamed, lightfast polyurethane molding prepared by a process comprising providing the polyurethane reaction mixture according to claim 10, and reacting the mixture in a closed mold.

15. A vehicle interior cladding component comprising a foamed, lightfast polyurethane molding according to claim 13.

16. A vehicle interior cladding component comprising a foamed, lightfast polyurethane molding according to claim 14.
